(19) United States
(12) Patent Application Publication
(10) Pub. No.: US 2025/0387911 A1
(43) Pub. Date: Dec. 25, 2025

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: PANASONIC INTELLECTUAL PROPERTY MANAGEMENT CO., LTD., Osaka (JP)

(72) Inventor: Masashi OKADA, Osaka (JP)

(73) Assignee: PANASONIC INTELLECTUAL PROPERTY MANAGEMENT CO., LTD., Osaka (JP)

(21) Appl. No.: 19/310,195

(22) Filed: Aug. 26, 2025

Related U.S. Application Data
(63) Continuation of application No. PCT/JP2024/003911, filed on Feb. 6, 2024.
(60) Provisional application No. 63/448,406, filed on Feb. 27, 2023.

(30) Foreign Application Priority Data
Dec. 11, 2023 (JP) 2023-208824

(51) Int. Cl. B25J 9/16; G06T 11/20

(52) U.S. Cl. CPC B25J 9/1664; B25J 9/163; B25J 9/1653; G06T 11/206; G05B 2219/39001; G05B 2219/40519

(57) ABSTRACT

An information processing device acquires trajectory information about a trajectory of a motion of a robot, adjusts parameters of the robot for optimizing two or more evaluation indicators for evaluating the motion of the robot, based on the trajectory information to calculate a plurality of optimal solutions of the two or more evaluation indicators, outputs a solution display image in which the calculated plurality of optimal solutions are rendered on a plane or in a space having the two or more evaluation indicators as a coordinate axis, acquires at least one optimal solution selected by a user from the plurality of optimal solutions displayed in the solution display image, and outputs reference information based on a history of the motion of the robot, the motion corresponding to the at least one optimal solution that has been acquired.

### FIELD OF INVENTION

The present disclosure relates to a technique for calculating a plurality of optimal solutions of two or more evaluation indicators for evaluating a motion of a robot and presenting the plurality of calculated optimal solutions.

### BACKGROUND ART

For example, a method disclosed in Patent Literature 1 includes receiving trajectory information defining a trajectory of a target motion of a robot, acquiring a value of an evaluation indicator of a control result in a case where the robot is caused to execute the target motion using each of one or more initial parameter sets in response to an instruction to adjust a parameter set for controlling the target motion, displaying one or more reference displays on a display part based on the acquired value of the evaluation indicator, and receiving input of the condition information about the evaluation indicator, the condition information defining a condition of optimization processing of the parameter set, and performing the optimization processing on the parameter set based on the condition information to determine values of a new parameter set.

However, in the above-described conventional technique, optimization of a single evaluation indicator is disclosed, but optimization of two or more evaluation indicators are not considered. It is thus difficult to assist a user in selecting one optimal solution from a plurality of optimal solutions, and further improvement is required.
Patent Literature 1: JP 2022-70451 A

### SUMMARY OF THE INVENTION

The present disclosure has been made to solve the above problem, and an object of the present disclosure is to provide a technique capable of optimizing two or more evaluation indicators and assisting a user in selecting one optimal solution from a plurality of optimal solutions.

An information processing method of the present disclosure is an information processing method executed by a computer, the method including acquiring trajectory information about a trajectory of a motion of a robot, adjusting parameters of the robot for optimizing two or more evaluation indicators for evaluating the motion of the robot, based on the trajectory information to calculate a plurality of optimal solutions of the two or more evaluation indicators, outputting a solution display image in which the calculated plurality of optimal solutions are rendered on a plane or in a space having the two or more evaluation indicators as a coordinate axis, acquiring at least one optimal solution selected by a user from the plurality of optimal solutions displayed in the solution display image, and outputting reference information based on a history of the motion of the robot, the motion corresponding to the at least one optimal solution that has been acquired.

The present disclosure enables two or more evaluation indicators to be optimized, and can assist a user in selecting one optimal solution from the plurality of optimal solutions.

### BRIEF DESCRIPTION OF THE DRAWINGS

FIG. 1 is a diagram illustrating a configuration of a teaching assist system according to a present embodiment.

FIG. 2 is a flowchart for explaining the teaching assist processing in an information processing device according to the embodiment of the present disclosure.

FIG. 3 is a diagram illustrating an example of a display screen for accepting inputs of two or more evaluation indicators and displaying a plurality of optimal solutions in the present embodiment.

FIG. 4 is a flowchart for explaining division processing in step S4 in FIG. 2.

FIG. 5 is a diagram illustrating an example of a reference information display screen displayed on a display part in the present embodiment.

FIG. 6 is a diagram illustrating an example of the reference information display screen displayed on the display part in a first modification of the present embodiment.

FIG. 7 is a diagram illustrating an example of the reference information display screen displayed on the display part in a second modification of the present embodiment.

FIG. 8 is a diagram illustrating an example of the reference information display screen displayed on the display part in a third modification of the present embodiment.

FIG. 9 is a diagram illustrating an example of the reference information display screen displayed on the display part in a fourth modification of the present embodiment.

FIG. 10 is a diagram illustrating an example of the reference information display screen displayed on the display part in a fifth modification of the present embodiment.

FIG. 11 is a diagram illustrating an example of the reference information display screen displayed on the display part in a sixth modification of the present embodiment.

FIG. 12 is a diagram illustrating an example of the reference information display screen displayed on the display part in a seventh modification of the present embodiment.

FIG. 13 is a graph showing a comparison result of a learning curve indicating growth of an area of a pareto optimal solution in a wiping motion.

FIG. 14 is a graph showing a comparison result of a learning curve indicating growth of an area of a pareto optimal solution in a door opening motion.

FIG. 15 is a table showing a comparison result between an area of a Pareto optimal solution in a case of using prior knowledge and the area of the Pareto optimal solution in a case of not using the prior knowledge in an IC-SLD method, a GMM method, and an SLD method.

### DETAILED DESCRIPTION

### (Knowledge Underlying Present Disclosure)

Robot control based on recording and playback of teaching is a technique widely used in the industrial world due to its intuitiveness and ease of implementation in a built-in system. In general, position control is used for playback of teaching, but the robot or the surroundings thereof are likely to be damaged by unexpected contact. Therefore, in order to achieve a motion of attaining a safe and desired task, it is essential to introduce impedance control with an appropriately designed stiffness parameter. The stiffness parameter affects motion safety and trajectory reproducibility, and the motion safety and trajectory reproducibility are in a trade-off relationship. Therefore, in the problem of determining the stiffness parameter, an evaluation indicator of task performance and an evaluation indicator of safety have to be optimized simultaneously.

However, in the above-described conventional technique, optimization of a single evaluation indicator is disclosed, but optimization of two or more evaluation indicators is not considered. It is thus difficult to assist a user in selecting one optimal solution from a plurality of optimal solutions.

In order to solve the above problem, a technique below is disclosed.

(1) An information processing method according to one aspect of the present disclosure is an information processing method executed by a computer, the method including acquiring trajectory information about a trajectory of a motion of a robot, adjusting parameters of the robot for optimizing two or more evaluation indicators for evaluating the motion of the robot, based on the trajectory information to calculate a plurality of optimal solutions of the two or more evaluation indicators, outputting a solution display image in which the calculated plurality of optimal solutions are rendered on a plane or in a space having the two or more evaluation indicators as a coordinate axis, acquiring at least one optimal solution selected by a user from the plurality of optimal solutions displayed in the solution display image, and outputting reference information based on a history of the motion of the robot, the motion corresponding to the at least one optimal solution that has been acquired.

According to this configuration, the two or more evaluation indicators can be optimized, and the plurality of optimal solutions of two or more evaluation indicators can be calculated. Further, since the reference information based on the history of the motion of the robot, the motion corresponding to the at least one optimal solution selected by the user from the plurality of optimal solutions, is presented to the user, this can assist the user in selecting one optimal solution from the plurality of optimal solutions.

(2) The information processing method according to (1) may further include accepting inputs of the two or more evaluation indicators from the user.

According to this configuration, since the inputs of two or more evaluation indicators is accepted from the user, the two or more evaluation indicators desired by the user can be optimized, and the plurality of optimal solutions of the two or more evaluation indicators can be calculated.

(3) In the information processing method according to (1) or (2), the calculation of the plurality of optimal solutions may include dividing the motion of the robot into a plurality of segments, and optimizing the two or more evaluation indicators by repeating search for a parameter among the parameters optimal in each segment with multi-objective Bayesian optimization.

According to this configuration, the motion of the robot is divided into the plurality of segments, and the search for the parameter optimal in each segment is repeated in the multi-objective Bayesian optimization, thereby optimizing two or more evaluation indicators. Therefore, the two or more evaluation indicators can be optimized.

(4) In the information processing method according to (3), the motion may be expressed by a plurality of combinations of motion equations of impedance control, the parameters may include a stiffness parameter of the impedance control, and the division of the motion may include estimating the stiffness parameter in each motion equation and a switching time of each motion equation so that an error between a predicted trajectory and a teaching trajectory in each motion equation is minimum.

According to this configuration, the motion can be divided into the plurality of segments based on the switching time of each motion equation, and the optimal stiffness parameter in each of the plurality of segments can be calculated based on the stiffness parameter in each motion equation.

(5) In the information processing method according to (4), the optimization of the two or more evaluation indicators may include weighting an acquisition function in the multi-objective Bayesian optimization with the estimated stiffness parameter, and repeating the search for the stiffness parameter optimal for each segment with the acquisition function.

According to this configuration, since the stiffness parameter estimated in advance is used in the multi-objective Bayesian optimization, the efficiency of the optimization processing can be improved.

(6) In the information processing method according to any one of (1) to (5), the reference information may include at least one piece of time-series data of the trajectory corresponding to the at least one optimal solution.

According to this configuration, the user can check the at least one piece of time-series data of the trajectory corresponding to the at least one optimal solution, thereby assisting the user in selecting one optimal solution from the plurality of optimal solutions.

(7) In the information processing method according to (6), in a case where among the plurality of optimal solutions, two or more optimal solutions are selected, two or more pieces of time-series data corresponding to the two or more optimal solutions may be displayed in a superimposed manner or a side-by-side manner.

According to this configuration, the user can easily compare the two or more pieces of time-series data corresponding to the two or more optimal solutions, respectively, thereby further assisting the user in selecting one optimal solution from the plurality of optimal solutions.

(8) In the information processing method according to (6), the at least one piece of time-series data corresponding to the at least one optimal solution and time-series data of a trajectory of a target motion of the robot may be displayed in a superimposed manner or a side-by-side manner.

According to this configuration, the user can easily compare the at least one time-series data corresponding to the at least one optimal solution with the time-series data of the trajectory of the target motion of the robot, thereby further assisting the user in selecting one optimal solution from the plurality of optimal solutions.

(9) In the information processing method according to (6), the at least one piece of time-series data corresponding to the at least one optimal solution and time-series data of at least one parameter changing in response to the motion corresponding to the at least one optimal solution may be displayed in a superimposed manner or a side-by-side manner.

According to this configuration, in addition to the at least one piece of time-series data corresponding to the at least one optimal solution, the user can also check the time-series data of the at least one parameter changing in response to the motion corresponding to the at least one optimal solution, thereby further assisting the user in selecting one optimal solution from the plurality of optimal solutions.

(10) In the information processing method according to any one of (1) to (5), the reference information may include at least one moving image obtained by recording the motion corresponding to the at least one optimal solution.

According to this configuration, the user can check the at least one moving image obtained by recording the motion corresponding to the at least one optimal solution, thereby assisting the user in selecting one optimal solution from the plurality of optimal solutions.

(11) In the information processing method according to (10), in a case where among the plurality of optimal solutions, two or more optimal solutions are selected, two or more moving images corresponding to the two or more optimal solutions may be displayed in a superimposed manner or a side-by-side manner.

According to this configuration, in a case where the two or more optimal solutions are selected from the plurality of optimal solutions, the two or more moving images corresponding to the two or more optimal solutions are displayed in a superimposed manner or a side-by-side manner.

Therefore, the user can easily compare the two or more moving images corresponding to the two or more optimal solutions, respectively, thereby further assisting the user in selecting one optimal solution from the plurality of optimal solutions.

(12) In the information processing method according to (10), the at least one moving image corresponding to the at least one optimal solution and a moving image obtained by recording a target motion of the robot may be displayed in a superimposed manner or a side-by-side manner.

According to this configuration, the user can easily compare the at least one moving image corresponding to the at least one optimal solution with the moving image obtained by recording the target motion of the robot, thereby further assisting the user in selecting one optimal solution from the plurality of optimal solutions.

(13) In the information processing method according to (10), the at least one moving image corresponding to the at least one optimal solution and time-series data of at least one parameter changing in response to the motion corresponding to the at least one optimal solution may be displayed side by side.

According to this configuration, in addition to the at least one moving image corresponding to the at least one optimal solution, the user can also check the time-series data of the at least one parameter changing in response to the motion corresponding to the at least one optimal solution, thereby further assisting the user in selecting one optimal solution from the plurality of optimal solutions.

(14) In the information processing method according to any one of (1) to (13), the two or more evaluation indicators may include an evaluation indicator of task performance and an evaluation indicator of safety.

According to this configuration, the evaluation indicator of the task performance and the evaluation indicator of safety in a trade-off relationship can be optimized.

Further, the present disclosure can be implemented not only as an information processing method for executing the characteristic processing as described above, but also as an information processing device or the like having a characteristic configuration corresponding to characteristic processing executed with the information processing method. Further, the present disclosure can also be implemented as a computer program that causes a computer to execute characteristic processing included in the information processing method described above. Therefore, even other aspects below can achieve an effect as in the above information processing method.

(15) An information processing device according to another aspect of the present disclosure includes a trajectory information acquisition part that acquires trajectory information about a trajectory of a motion of a robot, a calculation part that adjusts parameters of the robot for optimizing two or more evaluation indicators for evaluating the motion of the robot, based on the trajectory information to calculate a plurality of optimal solutions of the two or more evaluation indicators, a first output part that outputs a solution display image in which the calculated plurality of optimal solutions are rendered on a plane or in a space having the two or more evaluation indicators as a coordinate axis, an optimal solution acquisition part that acquires at least one optimal solution selected by a user from the plurality of optimal solutions displayed in the solution display image, and a second output part that outputs reference information based on a history of the motion of the robot, the motion corresponding to the at least one optimal solution that has been acquired.

(16) An information processing program according to another aspect of the present disclosure causes a computer to function to acquire trajectory information about a trajectory of a motion of a robot, adjust parameters of the robot for optimizing two or more evaluation indicators for evaluating the motion of the robot, based on the trajectory information to calculate a plurality of optimal solutions of the two or more evaluation indicators, output a solution display image in which the calculated plurality of optimal solutions are rendered on a plane or in a space having the two or more evaluation indicators as a coordinate axis, acquire at least one optimal solution selected by a user from the plurality of optimal solutions displayed in the solution display image, and output reference information based on a history of the motion of the robot, the motion corresponding to the at least one optimal solution that has been acquired.

(17) A non-transitory computer-readable recording medium according to another aspect of the present disclosure records an information processing program, the information processing program causing a computer to function to acquire trajectory information about a trajectory of a motion of a robot, adjust parameters of the robot for optimizing two or more evaluation indicators for evaluating the motion of the robot, based on the trajectory information to calculate a plurality of optimal solutions of the two or more evaluation indicators, output a solution display image in which the calculated plurality of optimal solutions are rendered on a plane or in a space having the two or more evaluation indicators as a coordinate axis, acquire at least one optimal solution selected by a user from the plurality of optimal solutions displayed in the solution display image, and output reference information based on a history of the motion of the robot, the motion corresponding to the at least one optimal solution that has been acquired.

Hereinafter, embodiments of the present disclosure will be described with reference to the accompanying drawings. Note that each of embodiments to be described below illustrates a specific example of the present disclosure. Numerical values, shapes, constituent elements, steps, order of steps, and the like in the embodiments below are merely examples, and do not intend to limit the present disclosure. A constituent element not described in an independent claim representing a highest concept among constituent elements in the embodiments below is described as an optional constituent element. Furthermore, in all the embodiments, respective contents can be combined.

### EMBODIMENTS

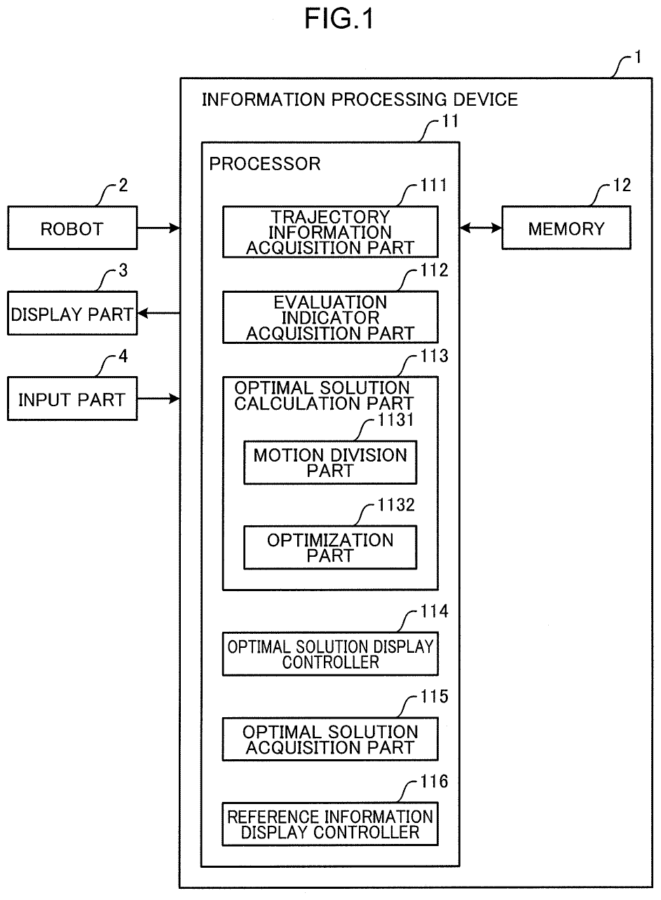

FIG. 1 is a diagram illustrating a configuration of a teaching assist system according to a present embodiment.

The teaching assist system illustrated in FIG. 1 includes an information processing device 1, a robot 2, a display part 3, and an input part 4.

The robot 2 executes a predetermined motion. The predetermined motion includes, for example, a motion that might cause contact between the robot 2 and a person or an object. A person teaches the robot 2 a predetermined motion.

The robot 2 includes a main body, an arm attached to the main body, and an end effector attached to a distal end portion of the arm. The robot 2 is a general-purpose robot that is enabled to carry out various tasks by teaching the robot 2 such various tasks. More specifically, the robot 2 is a single-arm robot in which various end effectors are attached to the arm when the robot is used. For example, the robot 2 is a six-axis robot, and the arm includes six link members and six joints. The main body and the six link members are connected by six joints.

An end effector is attached to the link member located at the distal end of the arm. The robot 2 is enabled to be at any attitude by driving the six-axis arm and moving the end effector to any position. The end effector is changed in accordance with a motion of the robot 2. For example, in a case where the robot 2 performs a door opening motion, the end effector is a member for gripping an object. For example, in a case where the robot 2 performs a table wiping motion, the end effector is a member such as sponge or cloth.

An acceleration sensor is attached to the link member located at the distal end of the arm together with the end effector. The acceleration sensor can acquire information about acceleration in directions of three axes perpendicular to each other and angular velocity about each axis. The robot 2 recognizes, based on the information, an inclination of the end effector, a moving speed including a speed and orientation of the end effector, and a current position of the end effector.

The robot 2 outputs trajectory information regarding a trajectory of the motion of the robot 2 to the information processing device 1. The robot 2 outputs, to the information processing device 1, trajectory information regarding a trajectory of the motion taught by a person to the robot 2. The trajectory information represents, for example, time-series data of coordinates in a three-dimensional space of the end effector attached to the distal end of the arm of the robot 2.

The robot 2 is connected to the information processing device 1 communicably with each other in a wired or wireless manner. Note that the robot 2 may be communicably connected to the information processing device 1 via a network. The network is a local area network or a wide area network.

The display part 3 is, for example, a liquid crystal display device, and displays information output from the information processing device 1. The display part 3 is connected to the information processing device 1 communicably with each other in a wired or wireless manner. Note that the display part 3 may be communicably connected to the information processing device 1 via a network. The network is a local area network or a wide area network.

The input part 4 is, for example, a keyboard, a mouse, or a touch panel, and accepts information input from a user. The input part 4 is connected to the information processing device 1 communicably with each other in a wired or wireless manner. Note that the input part 4 may be communicably connected to the information processing device 1 via a network. The network is a local area network or a wide area network.

The information processing device 1 includes a processor 11 and a memory 12. The information processing device 1 is, for example, a personal computer, a tablet computer, or a server.

The processor 11 is a central processing unit (CPU), for example. The processor 11 implements a trajectory information acquisition part 111, an evaluation indicator acquisition part 112, an optimal solution calculation part 113, an optimal solution display controller 114, an optimal solution acquisition part 115, and a reference information display controller 116.

The memory 12 is a storage device capable of storing various types of information, such as a random access memory (RAM), a hard disk drive (HDD), a solid state drive (SSD), or a flash memory. The memory 12 stores various types of information.

The memory 12 stores trajectory information output by the robot 2. The memory 12 stores a plurality of pieces of trajectory information corresponding to a plurality of motions of the robot 2.

Note that the memory 12 may store a moving image obtained by recording a motion of the robot 2 together with the trajectory information regarding the trajectory of a motion of the robot 2. The moving image is acquired from a camera that images a motion of the robot 2.

The trajectory information acquisition part 111 acquires the trajectory information regarding a trajectory of a motion of the robot 2. The trajectory information acquisition part 111 reads the trajectory information from the memory 12.

In the present embodiment, the trajectory information acquisition part 111 acquires the trajectory information created by a person actually teaching a motion to the robot 2, but the present disclosure is not particularly limited thereto. In a case where the person does not teach the motion to the robot 2 but the motion taught to the robot 2 is simulated by computer graphics in a virtual three-dimensional space, the trajectory information acquisition part 111 may acquire the trajectory information created by the simulation.

The input part 4 accepts inputs of two or more evaluation indicators for evaluating the motion of the robot 2 from the user. The display part 3 displays a screen for accepting the inputs of the two or more evaluation indicators from the user. The user inputs the two or more evaluation indicators on the displayed screen. The input part 4 outputs the two or more evaluation indicators input by the user to the information processing device 1.

The evaluation indicator acquisition part 112 acquires the two or more evaluation indicators input by the user from the input part 4.

The optimal solution calculation part 113 adjusts parameters of the robot 2 for optimizing the two or more evaluation indicators for evaluating the motion of the robot 2, based on the trajectory information acquired by the trajectory information acquisition part 111 to calculate a plurality of optimal solutions of the two or more evaluation indicators. The parameters are parameters for controlling the robot 2.

The optimal solution calculation part 113 includes a motion division part 1131 and an optimization part 1132.

The motion division part 1131 divides the motion of the robot 2 into a plurality of segments. The motion is expressed by a plurality of combinations of motion equations of impedance control. The parameters include a stiffness parameter of the impedance control. The motion division part 1131 estimates the stiffness parameter in each motion equation and a switching time (division time) of each motion equation so that an error between a predicted trajectory and a teaching trajectory in each motion equation is minimum.

For example, in a case where the motion of the robot 2 is a door opening motion, the motion division part 1131 divides the motion into a first segment in which the end effector approaches a handle of the door, a second segment in which the end effector grips and turns the handle of the door, and a third segment in which the end effector opens the door. In addition, for example, in a case where the motion of the robot 2 is a table wiping motion, the motion division part 1131 divides the motion into a first segment in which the end effector approaches a table top, a second segment in which the end effector comes touches the table top and stops, a third segment in which the end effector wipes the table top, and a fourth segment in which the end effector leaves the table top.

Here, the division processing in the motion division part 1131 will be described more specifically.

In the impedance control, the robot 2 moves according to a virtual motion equation of a spring, a mass, and a damper system in the following Expression (1).

$$\begin{matrix}[ Formula 1 ] & \\ Λ \ddot{x} + D \dot{x} + K ( {x}_{d} - x ) = F & ( 1 )\end{matrix}$$

Here, x∈R⁶ represents a position and attitude of the end effector in a task space, x_{d}∈R⁶ represents an attractor, and F∈R⁶ represents an external force acting on the end effector. Further, Λ∈R^{6*6} represents an inertia matrix, D∈R^{6*6} represents an attenuation matrix, and K∈R^{6*6} represents a stiffness matrix. The spring behavior implemented in the term of stiffness K enables the robot to follow a desired trajectory of an attractor xa while flexibly responding to an unexpected external force F. In order to adapt the system, the stiffness K has to be as low as possible.

The motion division part 1131 divides a task into a plurality of segments and assigns a stiffness parameter of a constant value to each segment, thereby reducing the number of input dimensions for the Bayesian optimization. Conventionally, such division processing has been performed manually, by clustering with a Gaussian mixture model (GMM), or by system identification based on switching linear dynamics (SLD). On the contrary, in the present embodiment, a division processing technique called impedance control aware switching linear dynamics (IC-SLD) is newly introduced, and this implements the division suitable for the impedance control. The SLD is suitable for a setting of assigning a certain parameter to a segment (alternatively, switching of the stiffness control). In IC-SLD, an impedance model of the Expression (1) is incorporated in advance to formulate an SLD identification problem. With this impedance control-aware formulation, segments suitable for the switching stiffness control to be performed during subsequent optimization are expected to be specified.

In the IC-SLD, the above motion equation is expressed by dynamics described below. At this time, it is assumed that the trajectory follows the stochastic linear dynamics in the following Expression (2).

$$\begin{matrix}[ Formula 2 ] & \\ p ( {x}_{1 : T} \vert {u}_{1 : T} , {s}_{1 : T} ) = {\prod }_{t = 1}^{T - 1} p ( {x}_{t + 1} \vert {x}_{t} , {u}_{t} , {s}_{t} = j ) & ( 2 )\end{matrix}$$

In the above Expression (2), a state vector xₜ is defined by the following Expression (3), and an action vector uₜ is defined by the following Expression (4). Here, Δxₜ represents residual from the attractor.

$$\begin{matrix}[ Formula 3 ] & \\ {x}_{t} := ( {\dot{x}}_{t} , {x}_{t} ) ∈ {ℝ}^{12} & ( 3 )\end{matrix}$$

$${u}_{t} := ( Δ {x}_{t} , {F}_{t} ) ∈ {ℝ}^{12} \qquad ( 4 )$$

In addition, p(xₜ₊₁|•) represents a linear Gaussian model expressed by the following Expression (5).

$$\begin{matrix}[ Formula 4 ] & \\ p ( {x}_{t + 1} \vert {x}_{t} , {u}_{t} , {s}_{t} = j ) := 𝒩 ( {x}_{t + 1} ; {A}_{j} {x}_{t} + {B}_{j} {u}_{t} , {\sum }_{j} ) & ( 5 )\end{matrix}$$

sₜ∈{1, 2, . . . , M} represents a hidden variable indicating a mode of dynamics, and M corresponds to the number of divisions. Aⱼ, Bⱼ, and Eⱼ are parameters of linear dynamics, and depend on the hidden variable sₜ=j. In the impedance control, Aⱼ and Bⱼ are expressed as the following Expressions (6) and (7) by discretizing the Expression (1) using an Euler method.

$$\begin{matrix}[ Formula 5 ] & \\ {A}_{j} = ( \begin{matrix}I - {Λ}^{- 1} \cdot 2 {K}_{j}^{\frac{1}{2}} Δ t & O \\ I \cdot Δ t & I\end{matrix} ) & ( 6 )\end{matrix}$$

$${B}_{j} - ( \begin{matrix}{Λ}^{- 1} {K}_{j} Δ t & {Λ}^{- 1} Δ t \\ O & O\end{matrix} ) \qquad ( 7 )$$

Here, a value proportional to the square root of the stiffness K is generally used as attenuation D. Therefore, the attenuation D is set as D=2K^{1/2}. In the Expressions (6) and (7), Δt represents a sampling period, I represents an identity matrix, and O represents a zero matrix.

Symbol Aⱼ represents a state matrix, and Bⱼ represents an input matrix or a control matrix. In the present embodiment, Aⱼ and Bⱼ are matrices obtained by discretizing a motion equation (mass, spring, and damper system) in the impedance control with a time width Δt using the Euler method.

The IC-SLD specifies dynamics parameters Aⱼ, Bⱼ, and ∈ⱼ with respect to a teaching trajectory X_{1:T} and infers (divides) a hidden variable sₜ=j. This can be achieved by optimizing objective functions expressed in the following Expressions (8), (9), and (10) with an expectation maximization (EM) algorithm.

$${EM}_{} ( θ , S ) := {\sum }_{t = 1}^{T - 1} {\sum }_{j = 1}^{M} {W}_{t}^{j} \cdot \qquad ( 8 )$$

$${W}_{t}^{j} := p ( {s}_{t} = j \vert {x}_{1 : T} , {u}_{1 : T} ) \qquad ( 9 )$$

$${t}_{j}^{} := log p ( {x}_{t + 1} \vert {x}_{t} , {u}_{t} , {s}_{t} = j ) \qquad ( 10 )$$

The EM algorithm numerically solves an optimization problem by repeatedly performing an E-step and an M-step until convergence. Here, in the E-step, W^{j}ₜ is calculated with a fixed dynamics parameter θ, and in the M-step, the dynamics parameter θ is updated by maximizing the Expression (6) with the fixed W^{j}ₜ. The motion division part 1131 infers the dynamics parameters θ ((Aⱼ, Bⱼ, and ∈ⱼ) and the hidden state S (hidden variable sₜ) with the EM algorithm.

The optimization part 1132 optimizes, with multi-objective Bayesian optimization, two or more evaluation indicators by repeating search for an optimal parameter of each segment with multi-objective Bayesian optimization. The optimization part 1132 weights the acquisition function in the multi-objective Bayesian optimization using the estimated stiffness parameter, and repeats the search for the optimal stiffness parameter of each segment with the acquisition function.

Here, the optimization processing in the optimization part 1132 will be described more specifically.

In the multi-objective optimization of the present embodiment, optimization of two objective functions is performed. In general, these objective functions are in a trade-off relationship. In the Bayesian optimization, as expressed in the following Expression (11), the optimization is performed by repeating the search for a solution candidate proposed by the acquisition function α(θ; Dₙ).

$$\begin{matrix}[ Formula 7 ] & \\ {θ}_{n + 1} = {arg max}_{θ ∈ Θ} α ( θ ; {𝒟}_{n} ) & ( 11 )\end{matrix}$$

Here, n indicates the number of repetitions, and Dₙ represents a history of past evaluation results. In the multi-objective optimization, there are a plurality of optimal solutions (Pareto optimal solutions) that express a best tradeoff. The acquisition function α(θ; Dₙ) is expressed as the following Expression (12). When a set of Pareto optimal solutions observed until the number of repetitions n is Y*_{1:n}, in the multi-objective Bayesian optimization, the acquisition function is defined so that a hypervolume indicator I_{H}(Y*_{1:n}) configured by Yⁿ_{1:n} is improved.

$$\begin{matrix}[ Formula 8 ] & \\ α ( θ ; {𝒟}_{n} ) = {𝔼}_{p ( y \vert θ )} [ [ {I}_{H} ( {Y}_{1 : n}^{*} ⋃ \{ y \} ) - {I}_{H} ( {Y}_{1 : n}^{*} ) ] ] & ( 12 )\end{matrix}$$

Symbol I_{H}(Yⁿ_{1:n}) represents the area of a region formed by the Pareto optimal solution. In the conventional Bayesian optimization, prior knowledge cannot be incorporated with methods other than narrowing the search space. However, such a method of giving prior knowledge might cause overlooking an important region, and thus an optimal solution cannot be obtained. Therefore, π-Bayesian optimization (BO) proposed in recent years proposes to introduce prior knowledge in the form of a probability distribution π(θ) into an acquisition function. The acquisition function α(θ; Dₙ) into which prior knowledge is introduced is expressed as the following Expression (13).

$$\begin{matrix}[ Formula 9 ] & \\ {α}_{π} \{ θ ; {𝒟}_{n} ) := α ( θ ; {𝒟}_{n} ) {π ( θ )}^{β / n} & ( 13 )\end{matrix}$$

Here, β∈R⁺ represents a hyperparameter reflecting the reliability of π(θ). Although the acquisition function gives a great weight to a prior distribution at the beginning of the optimization, as n increases, the exponent of the prior distribution is attenuated gradually, and α_{π} asymptotically approaches α.

The motion division part 1131 divides the trajectory of the motion into M segments, and estimates the stiffness parameter Kⱼ of each segment j∈{1, 2, . . . , M}. The optimization part 1132 uses the stiffness parameter θ of each segment estimated by the motion division part 1131 as prior knowledge.

In the present embodiment, the optimization part 1132 optimizes a task performance evaluation indicator for evaluating the degree of achievement of a task and a safety evaluation indicator indicating the safety of the impedance control using the multi-objective Bayesian optimization. This multi-objective optimization problem is formulated as expressed in the following Expression (14).

$$\begin{matrix}[ Formula 10 ] & \\ {arg max}_{θ ∈ Θ} {T}_{} ( θ \vert S ) , {C}_{} ( θ \vert S ) & ( 14 )\end{matrix}$$

In the Expression (14), J_{T}(θ|S) is an objective function of the task performance evaluation indicator, and J_{C}(θ|S) is an objective function of the safety evaluation indicator. Here, θ represents a set of stiffness parameters Kⱼ in each segment (θ={Kⱼ}^{M}ⱼ₌₁), and S represents a set of the hidden variables sₜ (division result)) (S={sₜ=j}^{T}ₜ₌₁).

The task performance objective function J_{T}(θ|S) is defined by a reward function or the like. The task performance objective function J_{T}(θ|S) is expressed as the following Expression (15).

$$\begin{matrix}[ Formula 11 ] & \\ {T}_{} ( θ \vert S ) := {{\sum }^{T}}_{t = 1} R ( {x}_{t} ) & ( 15 )\end{matrix}$$

In the Expression (15), R represents a task-specific reward function for evaluating each state xₜ, and the state transition is governed by K_{s1:T}.

Further, the safety objective function J_{C}(θ|S) is defined from time integration of the stiffness parameter. The safety objective function J_{C}(θ|S) is expressed as the following Expression (16).

$$\begin{matrix}[ Formula 12 ] & \\ {C}_{} ( θ \vert S ) := - {{\sum }^{T}}_{t = 1} \vert {K}_{{s}_{t}} \vert & ( 16 )\end{matrix}$$

The objective function in the Expression (16) sums the stiffness parameters at respective time steps (respective segments). The task performance objective function J_{T}(θ|S) and the safety objective function J_{C}(θ|S) are strongly affected by the set S.

Further, in the present embodiment, the optimization part 1132 utilizes the stiffness parameter included in the dynamics parameters identified by the IC-SLD as prior knowledge. The optimization part 1132 takes in the set S of segments determined by the motion division part 1131, and performs the multi-objective optimization of the Expression (14) in an actual environment using the most advanced Bayesian optimization method.

The optimal solution display controller 114 outputs a solution display image in which a plurality of optimal solutions calculated by the optimal solution calculation part 113 are rendered on a plane or in a space having two or more evaluation indicators as a coordinate axis. The optimal solution display controller 114 creates a solution display image and outputs the created solution display image to the display part 3.

The display part 3 displays the solution display image output by the optimal solution display controller 114. The input part 4 accepts, from a user, selection of at least one optimal solution among the plurality of optimal solutions displayed in the solution display image. The user selects at least one optimal solution from the plurality of optimal solutions displayed in the solution display image. The input part 4 outputs the at least one optimal solution selected by the user to the information processing device 1.

The optimal solution acquisition part 115 acquires, from the input part 4, the at least one optimal solution selected by the user from the plurality of optimal solutions displayed in the solution display image.

The reference information display controller 116 outputs reference information based on a history of a motion of the robot 2, the motion corresponding to the at least one optimal solution acquired by the optimal solution acquisition part 115. The reference information display controller 116 creates a reference information display screen for presenting the reference information, and outputs the created reference information display screen to the display part 3. The reference information includes time-series data of a trajectory corresponding to the at least one optimal solution.

The display part 3 displays the reference information output by the reference information display controller 116. The display part 3 displays the reference information display screen for presenting the reference information.

Thereafter, teaching assist processing in the information processing device 1 according to the embodiment of the present disclosure will be described.

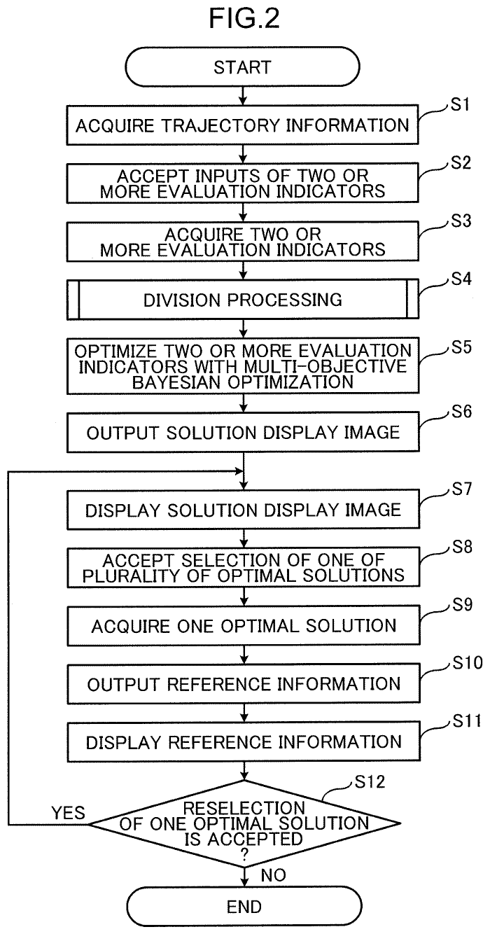

FIG. 2 is a flowchart for explaining the teaching assist processing in the information processing device 1 according to the embodiment of the present disclosure.

First, in step S1, the trajectory information acquisition part 111 acquires trajectory information regarding a trajectory of a motion of the robot 2.

In step S2, the input part 4 accepts inputs of two or more evaluation indicators for evaluating the motion of the robot 2 from the user. The user selects two evaluation indicators from the plurality of evaluation indicators.

In step S3, the evaluation indicator acquisition part 112 acquires the two or more evaluation indicators input by the user from the input part 4. The evaluation indicator acquisition part 112 acquires the two or more evaluation indicators from the input part 4.

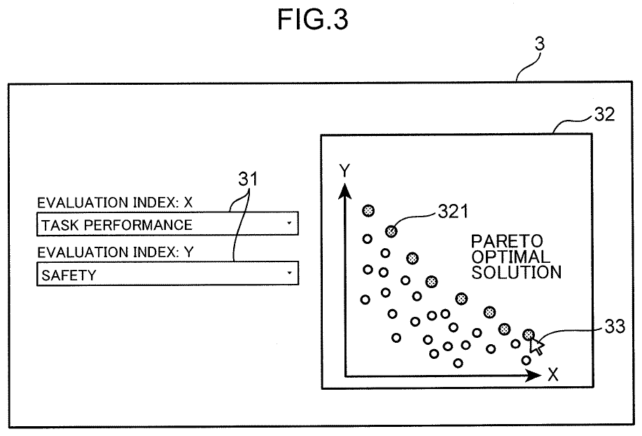

FIG. 3 is a diagram illustrating an example of a display screen for accepting the inputs of the two or more evaluation indicators and for displaying a plurality of optimal solutions in the present embodiment.

The display part 3 displays the display screen for accepts the inputs of the two or more evaluation indicators and displaying the plurality of optimal solutions. The display screen illustrated in FIG. 3 includes an evaluation indicator selection region 31 and an optimal solution display region 32.

The evaluation indicator selection region 31 shows a drop-down list indicating a plurality of selectable evaluation indicators, and accepts selection of two evaluation indicators by the user.

The user selects two desired evaluation indicators from the drop-down list displayed in the evaluation indicator selection region 31. The input part 4 accepts inputs of an evaluation indicator corresponding to an X axis and an evaluation indicator corresponding to a Y axis. In FIG. 3, task performance is selected as the evaluation indicator corresponding to the X axis, and safety is selected as the evaluation indicator corresponding to the Y axis.

Note that, in the present embodiment, the two or more evaluation indicators are selected by the user, but the present disclosure is not particularly limited thereto, and the two or more evaluation indicators to be optimized may be determined in advance.

Next, in step S4, the motion division part 1131 performs the division processing for dividing the motion of the robot 2 into a plurality of segments.

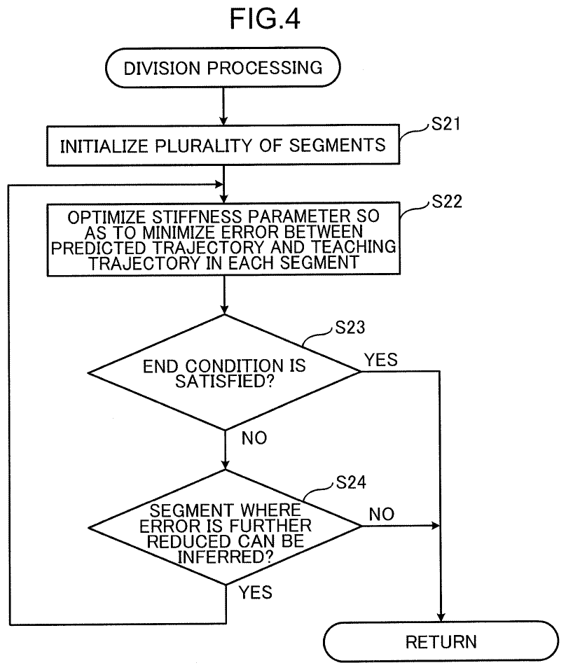

FIG. 4 is a flowchart for explaining the division processing in step S4 of FIG. 2.

First, in step S21, the motion division part 1131 initializes a plurality of segments based on a predetermined number of divisions. For example, in a case where the number of divisions is N, the motion division part 1131 initializes N−1 division times. As an initialization method, N equal division of a teaching motion is conceivable, but the present disclosure is not limited thereto. The motion division part 1131 may perform clustering on a teaching motion in advance and perform initialization based on a clustering result.

Next, in step S22, the motion division part 1131 optimizes the stiffness parameter so as to minimize the error between prediction trajectory and teaching trajectory of each segment. As the optimization method, the Newton method is used, but the present disclosure is not particularly limited thereto. In addition to the error, the motion division part 1131 may add a regularization term or the like for preventing the stiffness parameter from becoming excessively large to the objective function.

Next, in step S23, the motion division part 1131 determines whether an end condition is satisfied. The end condition is that the number of repetition times is greater than or equal to a threshold, or the error is smaller than or equal to a threshold. In a case where a determination is made that the end condition is satisfied (YES in step S23), the division processing is ended.

On the other hand, in a case where the determination is made that the end condition is not satisfied (NO in step S23), in step S24, the motion division part 1131 determines whether a segment where the error is further reduced can be inferred. In a case where the optimization result in step S22 can be differentiated by the division time, the division time can be inferred based on gradient information. Note that, in a case where the optimization result cannot be differentiated by the division time, inference by evolutionary computation is also possible. In this case, in step S22, the motion division part 1131 may create a plurality of segment candidates and calculate an error for each of the segment candidates. In step S24, the motion division part 1131 may perform inference based on statistical information about the calculated error. The method for creating the plurality of segment candidates includes a method for adding a perturbation based on a normal random number to the division time.

Here, in a case where the determination is made that the segment where the error is made smaller cannot be inferred (NO in step S24), the division processing ends.

On the other hand, in a case where the determined is made that the segment where the error is made smaller can be inferred (YES in step S24), the processing returns to step S22.

Returning to FIG. 2, in step S5, the optimization part 1132 optimizes two or more evaluation indicators with the multi-objective Bayesian optimization. The optimization part 1132 calculates a plurality of optimal solutions by optimizing the two evaluation indicators.

In next step S6, the optimal solution display controller 114 generates a solution display image in which the plurality of optimal solutions calculated by the optimization part 1132 are rendered in a plane or in a space having the two or more evaluation indicators as a coordinate axis, and outputs the generated solution display image to the display part 3.

In next step S7, the display part 3 displays the solution display image output by the optimal solution display controller 114.

As illustrated in FIG. 3, the display part 3 displays the solution display image in the optimal solution display region 32. In the solution display image, the X-axis represents an evaluation indicator of task performance, and the Y-axis represents an evaluation indicator of safety. The plurality of optimal solutions 321 are solutions that are not superior to any feasible solution, and are also called Pareto optimal solutions. In FIG. 3, the plurality of optimal solutions 321 are indicated by hatched points, and the plurality of feasible solutions other than the plurality of optimal solutions 321 are indicated by white points. In a case where the two evaluation indicators are maximized, the plurality of optimal solutions 321 are arranged on the upper right in the plane having the two evaluation indicators as a coordinate axis. The Pareto optimal solution and the plurality of feasible solutions other than the Pareto optimal solution are displayed in different modes. As a result, the user can visually recognize the Pareto optimal solution easily.

In addition, in the present embodiment, two evaluation indicators are selected and a plurality of optimal solutions of the two evaluation indicators are calculated, but the present disclosure is not particularly limited thereto. Three or more evaluation indicators may be selected and a plurality of optimal solutions of the three or more evaluation indicators may be calculated. For example, in a case where three evaluation indicators are selected and a plurality of optimal solutions of the three evaluation indicators are calculated, the optimal solution display controller 114 may output a solution display image in which the plurality of calculated optimal solutions are rendered in a three-dimensional space with the three evaluation indicators as a coordinate axis.

Further, in the present embodiment, a plurality of optimal solutions are displayed after the optimization of two or more evaluation indicators is completed, but the present disclosure is not particularly limited thereto. The plurality of optimal solutions may be sequentially displayed while the two or more evaluation indicators are being optimized before the optimization of the two or more evaluation indicators is completed. In this case, the user can check the progress of the optimization.

Returning to FIG. 2, in next step S8, the input part 4 accepts, from the user, selection of one optimal solution among the plurality of optimal solutions displayed in the solution display image.

As illustrated in FIG. 3, the display part 3 displays a pointer 33 that can be moved by a mouse. The user moves the pointer 33 over one optimal solution of the plurality of displayed optimal solutions 321 and clicks a mouse button. As a result, one optimal solution is selected from the plurality of optimal solutions 321. The input part 4 outputs, to the information processing device 1, information for specifying one optimal solution selected by the user from the plurality of optimal solutions displayed in the solution display image.

Returning to FIG. 2, in next step S9, the optimal solution acquisition part 115 acquires, from the input part 4, the one optimal solution selected by the user from the plurality of optimal solutions displayed in the solution display image.

In next step S10, the reference information display controller 116 outputs, to the display part 3, reference information based on a history of a motion of the robot 2, the motion corresponding to the one optimal solution acquired by the optimal solution acquisition part 115.

In next step S11, the display part 3 displays the reference information output by the reference information display controller 116. The display part 3 displays the reference information display screen for presenting the reference information.

The user selects one desired optimal solution from the plurality of optimal solutions by checking the reference information about each of the plurality of optimal solutions. Then, a parameter corresponding to the one optimal solution selected by the user is used for controlling the robot 2.

In next step S12, the input part 4 determines whether to accept reselection of one optimal solution from the plurality of optimal solutions. The reference information display screen displayed on the display part 3 may include a reselection button for accepting the reselection of one optimal solution from the plurality of optimal solutions. When the reselection button displayed on the reference information display screen is pressed, the input part 4 may determine to accept reselection of one optimal solution among the plurality of optimal solutions. Further, the reference information display screen displayed on the display part 3 may include an end button for ending the selection of one optimal solution among the plurality of optimal solutions. When the end button displayed on the reference information display screen is pressed, the input part 4 may determine not to accept the reselection of one optimal solution among the plurality of optimal solutions.

Here, in a case where the determination is made that the reselection of one optimal solution among the plurality of optimal solutions is accepted (YES in step S12), the processing returns to step S7.

On the other hand, in a case where the determination is made that the reselection of one optimal solution among the plurality of optimal solutions is not accepted (NO in step S12), the teaching assist processing is ended.

According to present embodiment, the two or more evaluation indicators can be optimized, and the plurality of optimal solutions of the two or more evaluation indicators can be calculated. Further, since the reference information based on the history of the motion of the robot 2, the motion corresponding to the at least one optimal solution selected by the user from the plurality of optimal solutions, is presented to the user, this can assist the user in selecting one optimal solution from the plurality of optimal solutions.

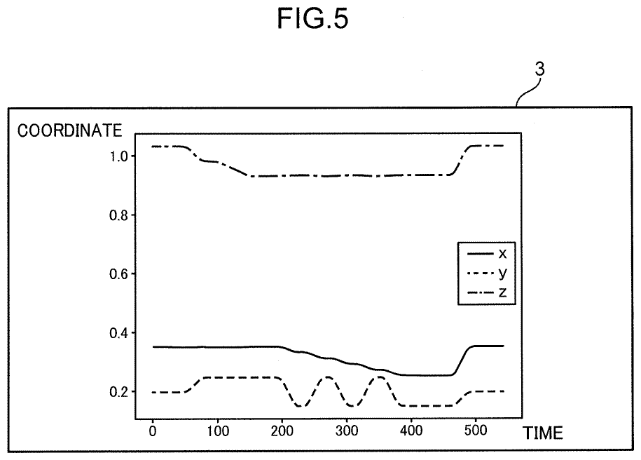

FIG. 5 is a diagram illustrating an example of the reference information display screen displayed on the display part 3 in the present embodiment. In FIG. 5, the horizontal axis represents time, and the vertical axis represents coordinates.

The reference information illustrated in FIG. 5 includes time-series data of a trajectory corresponding to the one optimal solution. In this case, the display part 3 displays the time-series data of the trajectory corresponding to one optimal solution. That is, the display part 3 displays the time-series data of an x coordinate, a y coordinate, and a z coordinate in the three-dimensional space of the end effector of the robot 2, the time-series data corresponding to the one optimal solution. The time-series data of the trajectory indicates a trajectory of the door opening motion of the robot 2.

In FIG. 5, the position of the x coordinate is indicated by a solid line, the position of the y coordinate is indicated by a broken line, and the position of the z coordinate is indicated by a dot-and-dash line. As described above, the time-series data of the x coordinate, the y coordinate, and the z coordinate are indicated by different types of lines, but the present disclosure is not particularly limited thereto, and may be indicated by lines of different colors.

In addition, in the present embodiment, the one optimal solution among the plurality of optimal solutions displayed in the solution display image is selected, but the present disclosure is not particularly limited thereto. The one feasible solution may be selected among the plurality of feasible solutions other than the plurality of optimal solutions displayed in the solution display image. In this case, the reference information based on the history of the motion of the robot 2, the motion corresponding to the one feasible solution is output. As a result, the user can check not only the reference information about the plurality of optimal solutions but also the reference information about the plurality of feasible solutions other than the plurality of optimal solutions.

Note that in the present embodiment, the one optimal solution is selected from the plurality of optimal solutions, but the present disclosure is not particularly limited thereto. In a first modification of the present embodiment, the two or more optimal solutions may be selected from the plurality of optimal solutions. In a case where the two or more optimal solutions are selected from the plurality of optimal solutions, the two or more pieces of time-series data respectively corresponding to the two or more optimal solutions may be displayed in a superimposed manner or a side-by-side manner.

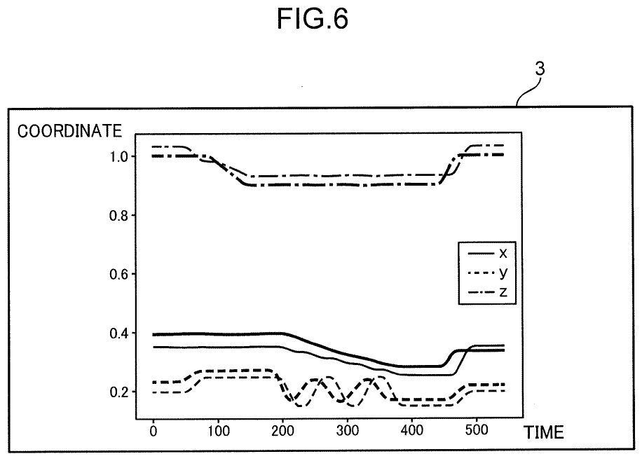

FIG. 6 is a diagram illustrating an example of the reference information display screen displayed on the display part 3 in the first modification of the present embodiment. In FIG. 6, the horizontal axis represents time, and the vertical axis represents coordinates.

In the first modification of the present embodiment, the input part 4 accepts, from the user, selection of two optimal solutions among the plurality of optimal solutions displayed in the solution display image. The optimal solution acquisition part 115 acquires, from the input part 4, the two optimal solutions selected by the user from the plurality of optimal solutions displayed in the solution display image. The reference information display controller 116 reads, from the memory 12, the two pieces of time-series data respectively corresponding to the two optimal solutions acquired by the optimal solution acquisition part 115, and outputs reference information obtained by superimposing the two pieces of time-series data to the display part 3. The display part 3 displays the reference information output by the reference information display controller 116.

The reference information display screen illustrated in FIG. 6 shows two pieces of time-series data of two trajectories respectively corresponding to the two optimal solutions in a superimposed manner. That is, the display part 3 displays two pieces of time-series data of the x coordinate, the y coordinate, and the z coordinate in the three-dimensional space of the end effector of the robot 2, the two pieces of time-series data respectively corresponding to the two optimal solutions, in a superimposed manner. In this case, the display part 3 displays first time-series data of the trajectory corresponding to the first optimal solution and second time-series data of the trajectory corresponding to the second optimal solution in a superimposed manner.

Note that the two pieces of time-series data respectively corresponding to the two optimal solutions are indicated by lines having different thicknesses, but the present disclosure is not particularly limited thereto, and may be indicated by lines having different colors. For example, the time-series data corresponding to one optimal solution may be indicated by a red line, and the time-series data corresponding to the other optimal solution may be indicated by a blue line.

Further, the reference information display screen may present the two pieces of time-series data of the two trajectories respectively corresponding to the two optimal solutions side by side. In this case, the display part 3 may display the first time-series data of the trajectory corresponding to the first optimal solution and the second time-series data of the trajectory corresponding to the second optimal solution side by side.

In the first modification of the present embodiment, the at least one piece of time-series data corresponding to the at least one optimal solution and the time-series data of a trajectory of a target motion of the robot may be displayed in a superimposed manner or a side-by-side manner. The target motion of the robot is taught, for example, by the user. The memory 12 may store the time-series data of the trajectory of the target motion of the robot.

Further, the reference information in the present embodiment includes the time-series data of the trajectory corresponding to the at least one optimal solution, but the present disclosure is not particularly limited thereto. The reference information in the second modification of the present embodiment may include a moving image obtained by recording a motion corresponding to the at least one optimal solution.

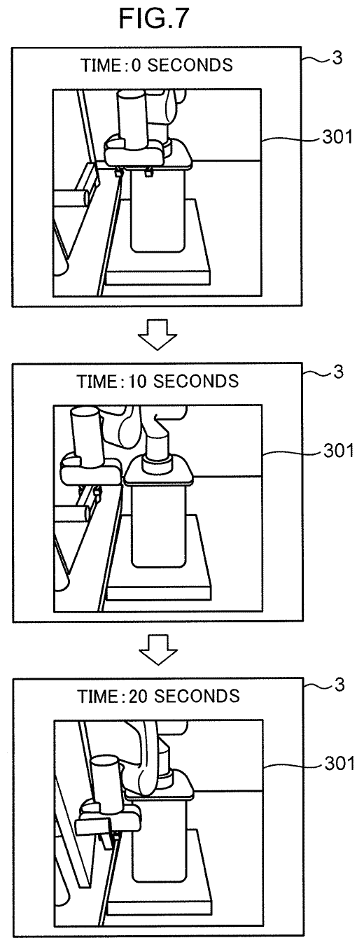

FIG. 7 is a diagram illustrating an example of the reference information display screen displayed on the display part 3 in the second modification of the present embodiment.

The reference information illustrated in FIG. 7 includes a moving image 301 obtained by recording a motion corresponding to one optimal solution. In this case, the display part 3 displays the moving image 301 obtained by recording the motion corresponding to one optimal solution. As illustrated in FIG. 7, an image with an elapsed time of 0 seconds, an image with an elapsed time of 10 seconds, and an image with an elapsed time of 20 seconds are cut out from the moving image 301. The moving image 301 shows a door opening motion of the robot 2.

In a third modification of the present embodiment, in a case where two or more optimal solutions are selected from the plurality of optimal solutions, two or more moving images obtained by recording motions corresponding to the two or more optimal solutions may be displayed side by side.

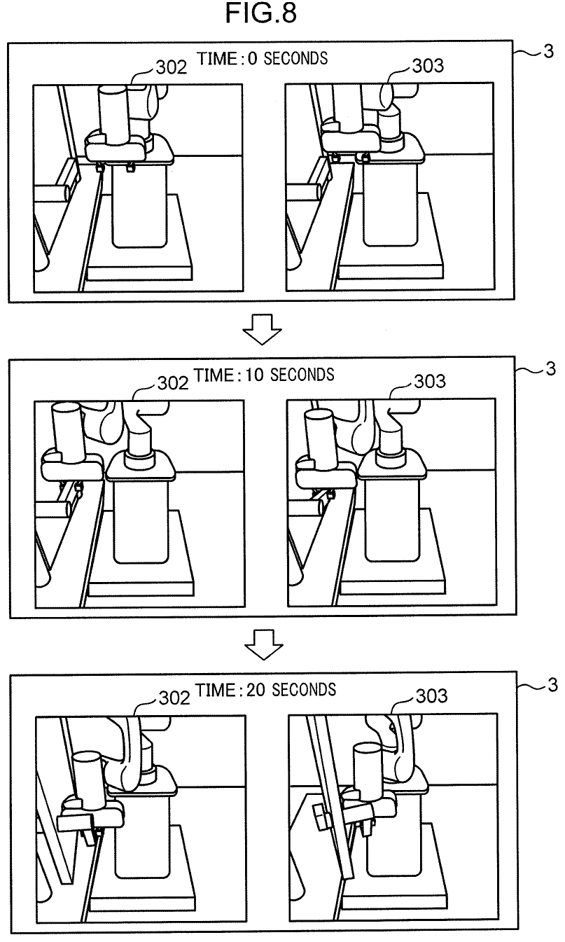

FIG. 8 is a diagram illustrating an example of the reference information display screen displayed on the display part 3 in the third modification of the present embodiment.

The reference information illustrated in FIG. 8 includes a first moving image 302 obtained by recording a motion corresponding to a first optimal solution selected by the user and a second moving image 303 obtained by recording a motion corresponding to a second optimal solution selected by the user. The reference information display screen illustrated in FIG. 8 presents two moving images obtained by recording two motions corresponding to two optimal solutions side by side. In this case, the display part 3 displays the first moving image 302 obtained by recording the motion corresponding to the first optimal solution and the second moving image 303 obtained by recording the motion corresponding to the second optimal solution side by side. As illustrated in FIG. 8, an image with an elapsed time of 0 seconds, an image with an elapsed time of 10 seconds, and an image with an elapsed time of 20 seconds are cut out from the first moving image 302 and the second moving image 303. The first moving image 302 and the second moving image 303 show the door opening motion of the robot 2.

In a fourth modification of the present embodiment, in a case where two or more optimal solutions are selected from the plurality of optimal solutions, two or more moving images obtained by recording motions corresponding to the two or more optimal solutions may be displayed in a superimposed manner.

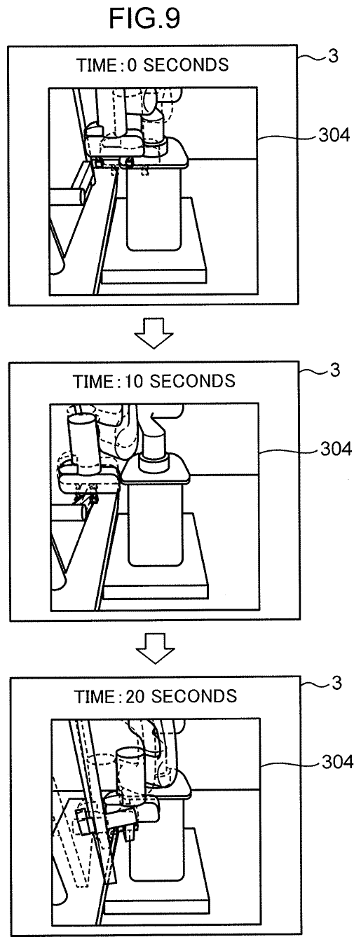

FIG. 9 is a diagram illustrating an example of the reference information display screen displayed on the display part 3 in the fourth modification of the present embodiment.

The reference information illustrated in FIG. 9 includes a combined moving image 304 obtained by superimposing the first moving image 302 obtained by recording the motion corresponding to the first optimal solution selected by the user and the second moving image 303 obtained by recording the motion corresponding to the second optimal solution selected by the user. The reference information display screen illustrated in FIG. 9 presents the two moving images obtained by recording two motions corresponding to the two optimal solutions in a superimposed manner. In this case, the display part 3 displays the combined moving image 304 obtained by superimposing the first moving image 302 obtained by recording the motion corresponding to the first optimal solution and the second moving image 303 obtained by recording the motion corresponding to the second optimal solution. For example, the reference information display controller 116 may create the combined moving image 304 by superimposing the semi-opaque second moving image 303 on the opaque first moving image 302. In FIG. 9, the first moving image 302 is indicated by a broken line, and the second moving image 303 is indicated by a solid line. As illustrated in FIG. 9, an image with an elapsed time of 0 seconds, an image with an elapsed time of 10 seconds, and an image with an elapsed time of 20 seconds are cut out from the combined moving image 304. The first moving image 302 and the second moving image 303 show the door opening motion of the robot 2.

By displaying two or more moving images in a superimposed manner, the user can intuitively grasp a difference between the two or more motions of the robot.

Further, in the third and fourth modifications of the present embodiment, the at least one moving images corresponding to the at least one optimal solution and the moving image obtained by recording a target motion of the robot may be displayed in a superimposed manner or a side-by-side manner. The target motion of the robot is taught, for example, by the user. The memory 12 may store the moving image obtained by recording the target motion of the robot.

In a fifth modification of the present embodiment, the at least one piece of time-series data of a trajectory corresponding to at least one optimal solution and time-series data of at least one parameter changing in response to the motion corresponding to the at least one optimal solution are displayed in a superimposed manner.

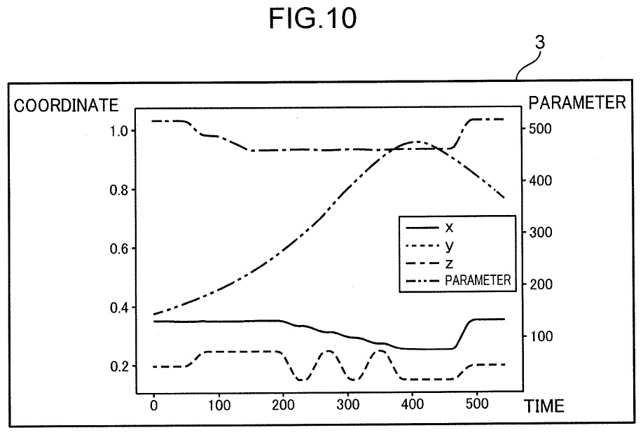

FIG. 10 is a diagram illustrating an example of the reference information display screen displayed on the display part 3 in the fifth modification of the present embodiment. In FIG. 10, a horizontal axis represents time, a vertical axis on the left represents coordinates, and a vertical axis on the right represents parameter values.

In the fifth modification of the present embodiment, the input part 4 accepts, from the user, selection of one optimal solution among the plurality of optimal solutions displayed in the solution display image. The optimal solution acquisition part 115 acquires, from the input part 4, the one optimal solution selected by the user from the plurality of optimal solutions displayed in the solution display image. The reference information display controller 116 reads the time-series data of the trajectory corresponding to the acquired one optimal solution and the time-series data of the parameter changing in response to the motion corresponding to the acquired one optimal solution from the memory 12, and outputs the reference information to the display part 3. In the reference information, the time-series data of the trajectory and the time-series data of the parameter are superimposed. The display part 3 displays the reference information output by the reference information display controller 116.

The reference information display screen illustrated in FIG. 10 presents the time-series data of the trajectory corresponding to one optimal solution and the time-series data of the parameter changing in response to the motion corresponding to the one optimal solution in a superimposed manner. That is, the display part 3 displays time-series data of the x coordinate, the y coordinate, and the z coordinate in the three-dimensional space of the end effector of the robot 2, the time-series data corresponding to the one optimal solution, and the time-series data of the parameter changing in response to the motion corresponding to the one optimal solution in a superimposed manner. The parameter is, for example, a stiffness parameter in impedance control. The time-series data of the trajectory indicates a trajectory of the door opening motion of the robot 2.

In FIG. 10, the position of the x coordinate is indicated by a solid line, the position of the y coordinate is indicated by a broken line, the position of the z coordinate is indicated by a dot-and-dash line, and the value of the parameter is indicated by a chain double-dashed line. As described above, the time-series data of the x coordinate, the y coordinate, and the z coordinate, and the time-series data of the parameter are indicated by different types of lines, but the present disclosure is not particularly limited thereto, and may be indicated by lines of different colors.

Further, the reference information display screen may show the at least one piece of time-series data of a trajectory corresponding to at least one optimal solution and time-series data of at least one parameter changing in response to the motion corresponding to the at least one optimal solution side by side. In this case, the display part 3 may display the at least one piece of time-series data of the trajectory corresponding to the at least one optimal solution and the time-series data of the at least one parameter changing in response to the motion corresponding to the at least one optimal solution side by side.

Further, in a sixth modification of the present embodiment, at least one moving image corresponding to at least one optimal solution and time-series data of at least one parameter changing in response to a motion corresponding to the at least one optimal solution may be displayed side by side.

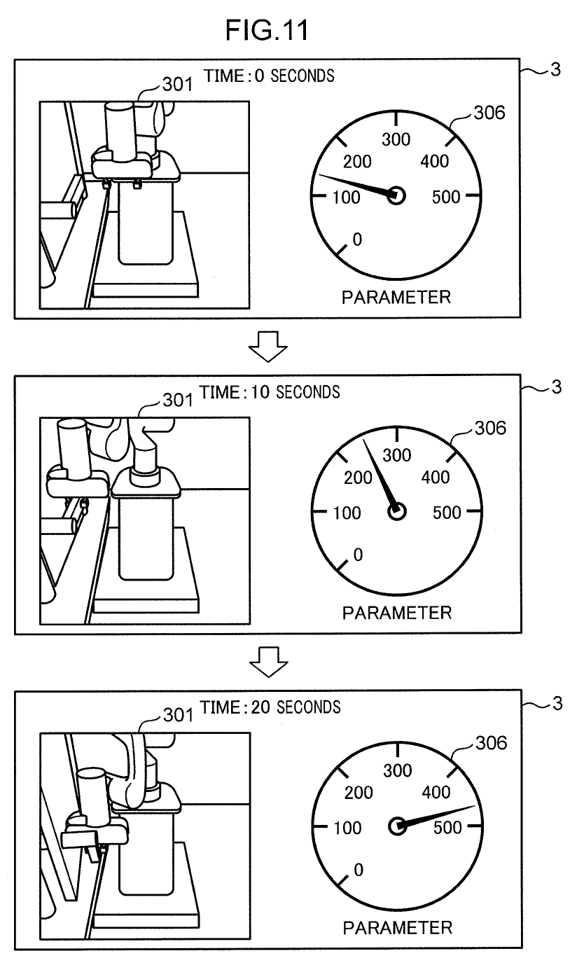

FIG. 11 is a diagram illustrating an example of the reference information display screen displayed on the display part 3 in the sixth modification of the present embodiment.

In the sixth modification of the present embodiment, the input part 4 accepts, from the user, selection of one optimal solution among the plurality of optimal solutions displayed in the solution display image. The optimal solution acquisition part 115 acquires, from the input part 4, the one optimal solution selected by the user from the plurality of optimal solutions displayed in the solution display image. The reference information display controller 116 reads the moving image corresponding to the acquired one optimal solution and the time-series data of the parameter changing in response to the motion corresponding to the acquired one optimal solution from the memory 12, and outputs the reference information to the display part 3. In the reference information, the moving image and the time-series data of the parameter are placed side by side. The display part 3 displays the reference information output by the reference information display controller 116.

The reference information illustrated in FIG. 11 includes the moving image 301 obtained by recording the motion corresponding to one acquired optimal solution and time-series data 306 of a parameter changing in response to the motion corresponding to the one acquired optimal solution. The reference information display screen illustrated in FIG. 11 presents the moving image corresponding to the one optimal solution and the time-series data of the parameter changing in response to the motion corresponding to the one optimal solution side by side. That is, the display part 3 displays the moving image 301 obtained by recording the motion corresponding to the one optimal solution and the time-series data 306 of the parameter changing according to the motion corresponding to the one optimal solution side by side. The parameter is, for example, a stiffness parameter in impedance control. As illustrated in FIG. 11, an image with an elapsed time of 0 seconds, an image with an elapsed time of 10 seconds, and an image with an elapsed time of 20 seconds are cut out from the moving image 301. The moving image 301 shows a door opening motion of the robot 2.

In addition, the time-series data 306 of a parameter is expressed by an analog indicator in which a needle moves on a circular dial. The values of the parameter are displayed around the dial, and the needle on the dial moves in accordance with a change in the value of a parameter.

Note that at least one moving image corresponding to at least one optimal solution and time-series data of at least one parameter changing in response to a motion corresponding to the at least one optimal solution may be displayed in a superimposed manner. The reference information display screen may present at least one moving image corresponding to at least one optimal solution and time-series data of at least one parameter changing in response to a motion corresponding to the at least one optimal solution in a superimposed manner. In this case, the display part 3 may display the at least one moving image corresponding to the at least one optimal solution and the time-series data of the at least one parameter changing in response to the motion corresponding to the at least one optimal solution in a superimposed manner. For example, the display part 3 may display the moving image and the time-series data of the parameter in a lower right portion of the moving image.

The time-series data of the parameter may be expressed by a numerical value.

Further, in a seventh modification of the present embodiment, a combined moving image and combined time-series data may be displayed side by side. The combined moving image is obtained by superimposing two or more moving images obtained by recording motions corresponding to two or more optimal solutions. The combined time-series data is obtained by superimposing two or more pieces of time-series data of two or more parameters changing in response to the motions corresponding to the two or more optimal solutions.

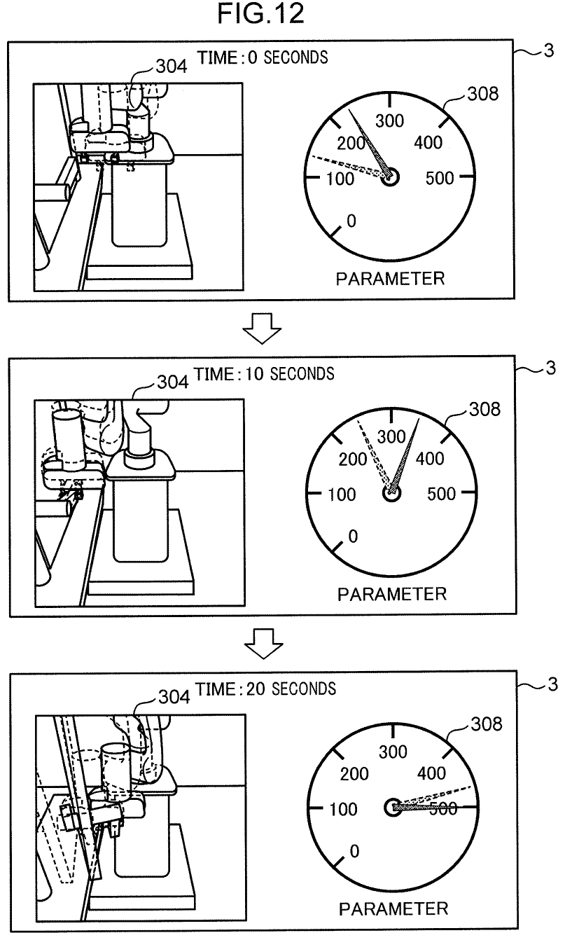

FIG. 12 is a diagram illustrating an example of the reference information display screen displayed on the display part 3 in the seventh modification of the present embodiment.

In the seventh modification of the present embodiment, the input part 4 accepts, from the user, selection of two optimal solutions among the plurality of optimal solutions displayed in the solution display image. The optimal solution acquisition part 115 acquires, from the input part 4, the two optimal solutions selected by the user from the plurality of optimal solutions displayed in the solution display image. The reference information display controller 116 reads, from the memory 12, two moving images corresponding to the acquired two optimal solutions and two pieces of time-series data of two parameters changing in response to motions corresponding to the acquired two optimal solutions, and outputs reference information to the display part 3. In the reference information, the combined moving image 304 obtained by superimposing the two moving images and the combined time-series data 308 obtained by superimposing the two pieces of time-series data of the two parameters are placed side by side. The display part 3 displays the reference information output by the reference information display controller 116.

The reference information illustrated in FIG. 12 includes the combined moving image 304 and the combined time-series data 308. The combined moving image 304 is obtained by superimposing the first moving image 302 obtained by recording a motion corresponding to a first optimal solution and the second moving image 303 obtained by recording a motion corresponding to a second optimal solution. The combined time-series data 308 is obtained by superimposing two pieces of time-series data of two parameters changing in response to motions corresponding to the acquired two optimal solutions. The reference information display screen illustrated in FIG. 12 presents the combined moving image obtained by superimposing two moving images obtained by recording two motions respectively corresponding to the two optimal solutions, and the combined time-series data obtained by superimposing two pieces of time-series data of two parameters changing in response to the motions respectively corresponding to the two optimal solutions, side by side.

In this case, the display part 3 displays the combined moving image 304 and the combined time-series data 308 side by side. The combined moving image 304 is obtained by superimposing the first moving image 302 obtained by recording a motion corresponding to the first optimal solution selected by the user and the second moving image 303 obtained by recording a motion corresponding to the second optimal solution selected by the user. The combined time-series data 308 is obtained by superimposing two pieces of time-series data of the two parameters changing in response to the motions corresponding to the two optimal solutions. For example, the reference information display controller 116 may create the combined moving image 304 by superimposing the semi-opaque second moving image 303 on the opaque first moving image 302. Note that in FIG. 12, the first moving image 302 is indicated by a broken line, and the second moving image 303 is indicated by a solid line. As illustrated in FIG. 12, an image with an elapsed time of 0 seconds, an image with an elapsed time of 10 seconds, and an image with an elapsed time of 20 seconds are cut out from the combined moving image 304. The first moving image 302 and the second moving image 303 show the door opening motion of the robot 2.

The parameter is, for example, a stiffness parameter in impedance control. The combined time-series data 308 of a parameter is indicated by an analog indicator in which a needle moves on a circular dial. The values of the parameter are displayed around the dial, and the needle on the dial moves in accordance with a change in the value of a parameter. In FIG. 12, the first time-series data of a parameter changing in response to the motion corresponding to the first optimal solution is indicated by a broken line, and the second time-series data of a parameter changing in response to the motion corresponding to the second optimal solution is indicated by a solid line.

Note that the combined moving image and the combined time-series data of a parameter may be displayed in a superimposed manner. The reference information display screen may present the combined moving image and the combined time-series data of a parameters in a superimposed manner. In this case, the display part 3 may display the combined moving image and the combined time-series data of a parameters in a superimposed manner. For example, the display part 3 may display the combined moving image and the combined time-series data of a parameter in a lower right portion of the combined moving image.

Further, two pieces of time-series data of a parameter may be expressed by numerical values.

Subsequently, simulation results of the division processing and the optimization processing in the present embodiment will be described.

In the simulation, two simulation tasks and tasks using an actual robot are adopted. The simulation tasks include a table wiping motion and a door opening motion. Further, the wiping motion was performed in an actual environment using an actual robot. The objective functions of these tasks were the sum of task-specific reward functions R(xₜ). The reward of the simulation task is a binary variable indicating success or failure, and “1” indicates that the current state is a task completion state (that is, dirt is cleaned or a door is opened). The reward of an actual task was represented by a negative square error between an achieved position trajectory and a demonstrated position trajectory.

As a conventional division method to be compared, a conventional GMM method and a conventional SLD method in which impedance control was excluded were adopted. In the conventional SLD method, Aⱼ is expressed as the following Expression (17), and Bⱼ is expressed by the following expression (18). In this formulation, a dynamics parameter and a segment identifier were estimated by optimizing the Expression (8) using the EM algorithm.

$${A}_{j} = diag ( {a}_{1} , {a}_{2} , … , {a}_{6} ) ∈ {R}^{6 * 6} \qquad ( 17 )$$

$${B}_{j} = ( diag ( {b}_{1} , {b}_{2} , … , {b}_{6} ) , diag ( {b}_{1}^{′} , {b}_{2}^{′} , … , {b}_{6}^{′} ) ) ∈ {R}^{6 * 12} \qquad ( 18 )$$

In the conventional GMM method and the conventional SLD method, π-BO was not applied to the Bayesian optimization processing unless otherwise specified.

The effectiveness of the proposed method in the present embodiment was examined by simulation. For each setting, 10 simulations were performed with different random seeds, and the results of the statistics (averages) were compared.

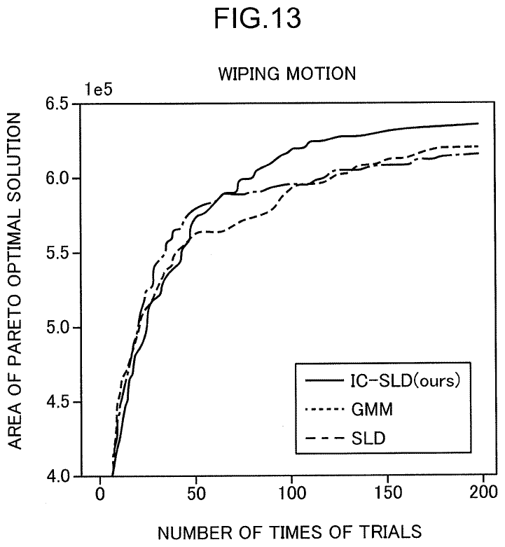

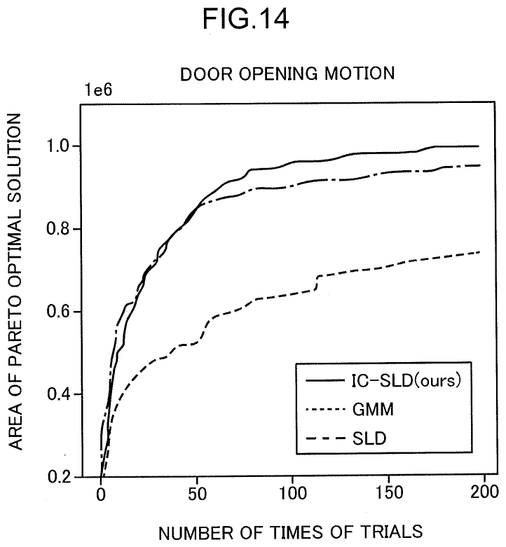

FIG. 13 is a diagram illustrating a comparison result of the learning curve indicating the growth of the area of the Pareto optimal solution in the wiping motion. FIG. 14 is a diagram illustrating a comparison result of the learning curve indicating the growth of the area of the Pareto optimal solution in the door opening motion.

In FIGS. 13 and 14, a solid line indicates a simulation result in the IC-SLD method of the present embodiment, a broken line indicates a simulation result in the conventional GMM method, and a dot-and-dash line indicates a simulation result in the conventional SLD method. In FIGS. 13 and 14, a horizontal axis represents the number of times of trial, and a vertical axis represents the area of the Pareto optimal solution (Hypervolume indicator: I_{H}(Y)).

FIGS. 13 and 14 illustrate the progress of optimization obtained with the IC-SLD method of the present embodiment, the conventional GMM method, and the conventional SLD method. The number of divisions M of the wiping motion was set to two, and the number of divisions of the door opening motion was set to three. Further, in the optimization processing of the present embodiment, the hyperparameter β of π-BO was set to 1. As illustrated in FIGS. 13 and 14, with the IC-SLD method of the present embodiment, two evaluation indicators was optimized most efficiently, and convergence was achieved in about 100 trials.

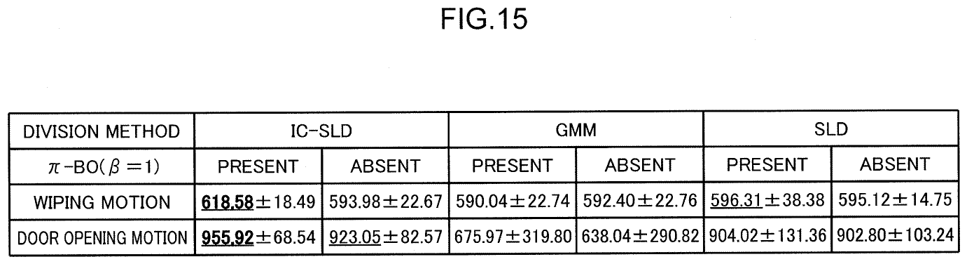

FIG. 15 is a table showing a comparison result between an area of the Pareto optimal solution in a case of using prior knowledge and an area of the Pareto optimal solution in a case of not using the prior knowledge in the IC-SLD method, the GMM method, and the SLD method.

An ablation analysis was performed to check whether the presence or absence of prior knowledge of π-BO contributed to the improvement of the optimization processing. In the ablation analysis, the wiping motion and the door opening motion were divided in each of the IC-SLD method, the GMM method, and the SLD method. In addition, two evaluation indicators were optimized using the prior knowledge of π-BO in each of the IC-SLD method, the GMM method, and the SLD method, and two evaluation indicators were optimized without using the prior knowledge of π-BO in each of the IC-SLD method, the GMM method, and the SLD method.

Note that the numerical values in FIG. 15 indicate average values of results of a plurality of experiments, and the numerical values after ± indicates errors with respect to the average values.

As illustrated in FIG. 15, it can be found that the performance is most improved in a case where the motion is divided with the IC-SLD method, and the two evaluation indicators are optimized using the previous knowledge of π-BO. This result indicates that both the IC-SLD method and the previous knowledge of π-BO contribute to performance improvement.

Note that a parameter to be optimized in the present embodiment is a stiffness parameter in the impedance control, but the present disclosure is not particularly limited thereto, and may be a damper parameter in the impedance control. The parameter may be a P gain, an I gain, or a D gain in proportional integral differential (PID) control. Further, the parameter may be a selection coefficient of force control or a selection coefficient of position control in hybrid control of the force control and the position control.

Note that, in each of the above embodiments, each constituent element may be implemented by including dedicated hardware or by executing a software program suitable for each constituent element. Each constituent element may be implemented by a program execution unit, such as a CPU or a processor, reading and executing a software program recorded in a recording medium such as a hard disk or a semiconductor memory. Further, a program may be executed by another independent computer system by recording and transferring the program onto a recording medium or transferring the program via a network.

Some or all of the functions of the devices according to the embodiments of the present disclosure are implemented as large scale integration (LSI), which is typically an integrated circuit. These may be individually integrated into one chip, or may be integrated into one chip so as to include some or all of these. Further, circuit integration is not limited to LSI, and may be implemented by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Further, some or all functions of the devices according to the embodiments of the present disclosure may be implemented by a processor such as a CPU executing a program.

All numerical figures used above are illustrated to specifically describe the present disclosure, and the present disclosure is not limited to the illustrated numerical figures.

Order in which steps illustrated in the above flowchart are executed is for specifically describing the present disclosure, and may be any order other than the above order as long as a similar effect is obtained. Further, some of the above steps may be executed simultaneously (in parallel) with other steps.

Since the technique of the present disclosure enables optimization of two or more evaluation indicators and can assist the user in selecting one optimal solution from a plurality of optimal solutions, this technique is useful as a technique for calculating a plurality of optimal solutions of two or more evaluation indicators for evaluating a motion of a robot and presenting the plurality of calculated optimal solutions.

1. An information processing method executed by a computer, the method comprising:
acquiring trajectory information about a trajectory of a motion of a robot;
adjusting parameters of the robot for optimizing two or more evaluation indicators for evaluating the motion of the robot, based on the trajectory information to calculate a plurality of optimal solutions of the two or more evaluation indicators;
outputting a solution display image in which the calculated plurality of optimal solutions are rendered on a plane or in a space having the two or more evaluation indicators as a coordinate axis;
acquiring at least one optimal solution selected by a user from the plurality of optimal solutions displayed in the solution display image; and
outputting reference information based on a history of the motion of the robot, the motion corresponding to the at least one optimal solution that has been acquired.

2. The information processing method according to claim 1, further comprising accepting inputs of the two or more evaluation indicators from the user.

3. The information processing method according to claim 1, wherein
the calculation of the plurality of optimal solutions includes
dividing the motion of the robot into a plurality of segments, and
optimizing the two or more evaluation indicators by repeating search for a parameter among the parameters optimal in each segment with multi-objective Bayesian optimization.

4. The information processing method according to claim 3, wherein
the motion is expressed by a plurality of combinations of motion equations of impedance control,
the parameters include a stiffness parameter of the impedance control, and
the division of the motion includes estimating the stiffness parameter in each motion equation and a switching time of each motion equation so that an error between a predicted trajectory and a teaching trajectory in each motion equation is minimum.

5. The information processing method according to claim 4, wherein the optimization of the two or more evaluation indicators includes weighting an acquisition function in the multi-objective Bayesian optimization with the estimated stiffness parameter, and repeating the search for the stiffness parameter optimal for each segment with the acquisition function.

6. The information processing method according to claim 1, wherein the reference information includes at least one piece of time-series data of the trajectory corresponding to the at least one optimal solution.

7. The information processing method according to claim 6, wherein in a case where among the plurality of optimal solutions, two or more optimal solutions are selected, two or more pieces of time-series data corresponding to the two or more optimal solutions are displayed in a superimposed manner or a side-by-side manner.

8. The information processing method according to claim 6, wherein the at least one piece of time-series data corresponding to the at least one optimal solution and time-series data of a trajectory of a target motion of the robot are displayed in a superimposed manner or a side-by-side manner.

9. The information processing method according to claim 6, wherein the at least one piece of time-series data corresponding to the at least one optimal solution and time-series data of at least one parameter changing in response to the motion corresponding to the at least one optimal solution are displayed in a superimposed manner or a side-by-side manner.

10. The information processing method according to claim 1, wherein the reference information includes at least one moving image obtained by recording the motion corresponding to the at least one optimal solution.

11. The information processing method according to claim 10, wherein in a case where among the plurality of optimal solutions, two or more optimal solutions are selected, two or more moving images corresponding to the two or more optimal solutions are displayed in a superimposed manner or a side-by-side manner.

12. The information processing method according to claim 10, wherein the at least one moving image corresponding to the at least one optimal solution and a moving image obtained by recording a target motion of the robot are displayed in a superimposed manner or a side-by-side manner.

13. The information processing method according to claim 10, wherein the at least one moving image corresponding to the at least one optimal solution and time-series data of at least one parameter changing in response to the motion corresponding to the at least one optimal solution are displayed side by side.

14. The information processing method according to claim 1, wherein the two or more evaluation indicators include an evaluation indicator of task performance and an evaluation indicator of safety.

15. An information processing device comprising:
a trajectory information acquisition part that acquires trajectory information about a trajectory of a motion of a robot;
a calculation part that adjusts parameters of the robot for optimizing two or more evaluation indicators for evaluating the motion of the robot, based on the trajectory information to calculate a plurality of optimal solutions of the two or more evaluation indicators;
a first output part that outputs a solution display image in which the calculated plurality of optimal solutions are rendered on a plane or in a space having the two or more evaluation indicators as a coordinate axis;
an optimal solution acquisition part that acquires at least one optimal solution selected by a user from the plurality of optimal solutions displayed in the solution display image; and
a second output part that outputs reference information based on a history of the motion of the robot, the motion corresponding to the at least one optimal solution that has been acquired.

16. A non-transitory computer readable recording medium storing an information processing program causing a computer to function to:
acquire trajectory information about a trajectory of a motion of a robot;
adjust parameters of the robot for optimizing two or more evaluation indicators for evaluating the motion of the robot, based on the trajectory information to calculate a plurality of optimal solutions of the two or more evaluation indicators;
output a solution display image in which the calculated plurality of optimal solutions are rendered on a plane or in a space having the two or more evaluation indicators as a coordinate axis;
acquire at least one optimal solution selected by a user from the plurality of optimal solutions displayed in the solution display image; and
output reference information based on a history of the motion of the robot, the motion corresponding to the at least one optimal solution that has been acquired.
